(19) United States
(12) Patent Application Publication
(10) Pub. No.: US 2011/0306694 A1
(43) Pub. Date: Dec. 15, 2011

(54) Method of producing cold foams

(75) Inventors: Martin Glos, Borken (DE); Frauke Henning, Essen (DE); Mladen Vidakovic, Duisburg (DE)

(73) Assignee: Evonik Goldschmidt GmbH, Essen (DE)

(21) Appl. No.: 13/144,767

(22) PCT Filed: Dec. 14, 2009
(86) PCT No.: PCT/EP09/67045

§ 371 Date: Jul. 15, 2011

(51) Int. Cl. C08J 9/00; C09K 3/00; C07F 7/18; C08L 75/04; C07F 7/08

(52) U.S. Cl. 521/112; 556/436; 556/454; 556/456; 556/453; 252/182.29

(57) ABSTRACT

The invention relates to compositions comprising linear siloxanes, comprising only one further organically modified group in addition to the Si-alkyl substitution in the siloxane chain, wherein said group is bonded to a terminal silicon atom, and to the use thereof for producing polyurethane cold foams.

The invention relates to the production of cold-cure polyurethane foams using linear polyethersiloxanes.

Cold-cure polyurethane foams are also referred to as “cold-cure foams” or “high-resilience foams (HR foams)”.

Highly elastic cold-cure polyurethane foams are widely used for producing mattresses, upholstered furniture or automobile seats. They are produced by reaction of isocyanates with polyols. Specific siloxanes, or siloxane surfactants, serve to stabilize the expanding foam in the production of cold-cure polyurethane foams. They ensure that a regular cell structure is formed and no defects occur in the foam.

### PRIOR ART

Various structures are used as siloxanes.

US 2007/0072951 describes siloxanes which bear two terminal silanol units and their used in the production of cold-cure polyurethane foam.

EP 1 753 799 A1 describes the production of polyurethane foam using siloxanes which bear two terminal OH functions, with the OH function being bound to the silicon atom via an alkylene unit.

When siloxane structures bear OH functions or other isocyanate-reactive groups, the siloxane is incorporated into the polymer matrix during foaming and is therefore no longer available as surface-active substance or surfactant. Particularly when the siloxane bears a plurality of reactive groups, it can additionally act as a crosslinker. There is therefore an increased risk that cell opening will be insufficient and the foam will shrink during cooling after foaming.

EP 1 095 968 A1 describes the production of cold-cure foams using polydimethylsiloxanes which have a particularly narrow chain length distribution and therefore comprise over 90% of siloxanes having the chain lengths N=7-9. These siloxanes are not incorporated by reaction into the polymer matrix, and their surface-active properties are therefore retained to the end of foaming. However, when polydimethylsiloxanes are used, the problem that these substances are later emitted from the foam arises, which is particularly undesirable in uses in the automobile sector.

DE 3234462 C1 describes a process for producing highly elastic cold-curing polyurethane foams, in which polyether-modified siloxanes which contain 4-25 silicon atoms, are modified with from 1.5 to 10 polyether units in the siloxane molecule and contain polyether units having differing proportions of oxyethylene (EO) and oxypropylene (PO) units are used. No polyether-modified siloxanes which contain less than 1.5 modifications per molecule are described here.

Thus, siloxanes having very different structural features are used, since the tasks performed by the siloxane during foaming can likewise be very different. Firstly, settling of the foam should be avoided during foaming. Secondly, sufficient cell opening should take place after the maximum foam height has been reached. In addition, the mixture to be foamed has to travel along often complicated flow paths, particularly in the case of foaming in a mold, and should have no defects in the foam structure after foaming is complete. A further requirement is avoidance of volatile substances which are given off from the finished foam. There is therefore a desire for siloxanes which make very little contribution to these emissions.

There was therefore a need for compositions which comprise siloxane structures and can meet these complex and varying requirements.

It has surprisingly been found that the object of the invention can be achieved using linear siloxanes which contain only one further organically modifying group in addition to the Si-alkyl substitution in the chain, with this group being bound to a terminal silicon atom.

The compositions of the invention contain siloxanes which can be described by the general formula (I),

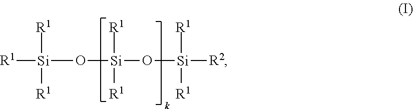

where
the radicals R¹ are identical or different, straight-chain or branched, aliphatic or aromatic, optionally halogenated, optionally unsaturated hydrocarbon radicals having from 1 to 8 carbon atoms, preferably having one carbon atom or a methyl group,
k is from 0 to 30, preferably from 0 to 10, and when only one compound of the formula (I) is present k is the actual number of the units denoted by the index k and when a plurality of compounds of the formula (I) is present is the average of the number of units,
R² is a group of the formula A-B-D-Q, where
   A is an oxygen atom, a CH₂ group or a CH═CH group,
   B is a CH₂ group or a divalent radical selected from among linear or branched, saturated, monounsaturated or multiply unsaturated alkyloxy, aryloxy, alkylaryloxy or arylalkyloxy groups having from 2 to 20 carbon atoms or a group of the formula —CH₂—O—(CH₂)₄—O— (where this is inserted as A-CH₂—O—(CH₂)₄—O-D-Q in R²),
   D is a group of the general formula (II)

—(C₂H₄O)ₙ(C₃H₆O)ₒ(C₁₂H₂₄O)ₚ(C₈H₈O)_{q}(C₄H₈O)ᵣ— (II)
where
n, o, p, q and r are independently integers from 0 to 50, where the sum of the indices n+o+p+q+r is greater than or equal to 3 and the general formula (II) represents a random oligomer or a block oligomer (where, in formula (II), C₁₂H₂₄O is dodecene oxide and C₈H₈O is styrene oxide) and
Q is a radical selected from among hydrogen, linear or branched, saturated, monounsaturated or multiply unsaturated, alkyl, aryl, alkylaryl or arylalkyl groups having from 1 to 20 carbon atoms, optionally containing one or more heteroatoms, optionally containing one or more carbonyl groups, optionally modified with an ionic organic group, which can, for example, contain the heteroatoms sulfur, phosphorus and/or nitrogen,
or industrial mixtures containing these compounds or consisting of at least one compound of the formula (I) in the production of cold-cure polyurethane foams.

As can be seen from the definition of the radical R², the radical R² can be bound via a carbon atom (SiC bonding) or an oxygen atom (SiOC bonding).

The composition preferably comprises or consists of compounds of the formula (I) in which all radicals R¹ of the general formula (I) are methyl groups. The composition preferably comprises or consists of compounds of the formula (I) in which the radicals R¹ of the general formula (I) are methyl groups, p=q=r=0, the sum of the indices n+o is greater than or equal to 3 and Q is selected from the group consisting of hydrogen and

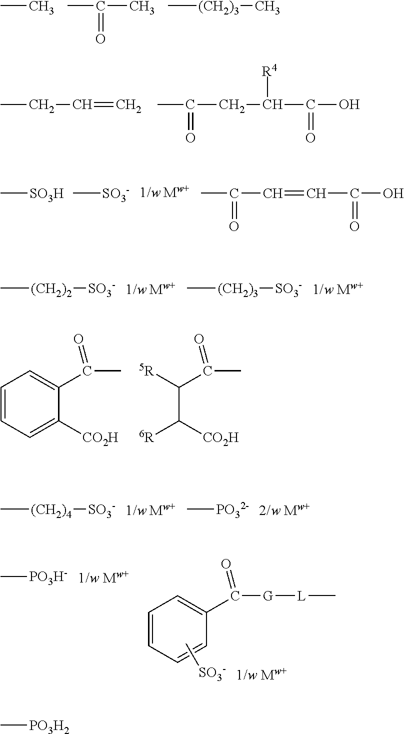

where
M^{w+} is a w-valent cation where w=1, 2, 3 or 4, in particular K⁺, Na⁺, NH₄⁺, (iC₃H₇)NH₃⁺ or (CH₃)₄N⁺ and
R⁴ is hydrogen or an optionally branched aliphatic radical having from 1 to 20 carbon atoms,
R⁵ and R⁶ are identical or different, bridged or unbridged, branched or unbranched aliphatic radicals,
G is an oxygen atom, NH or an NR⁷ group, where R⁷ is a monovalent alkyl group,
L is a divalent branched or unbranched, optionally oxygen- and/or nitrogen-containing, alkyl radical, preferably a radical having from 3 to 6 carbon atoms and 0 or 1 nitrogen atoms.

The composition preferably comprises or consists of compounds of the formula (I) in which the radicals R¹ of the general formula (I) are exclusively methyl groups, p=q=r=0, the sum of the indices n+o is greater than or equal to 3 and Q is selected from the group consisting of hydrogen, acetyl, methyl, ethyl, butyl and allyl radicals.

It will be self-evident to a person skilled in the art that the compounds are present in the form of a mixture having a distribution which is regulated essentially by laws of statistics. For example, a mixture of compounds of the formula (I) having k=1, 2, 3 and 4, etc., can be present in the composition. For the purposes of the invention, it has been found to be particularly advantageous when the compounds of the general formula (I) are used as a mixture. A complicated separation can then be dispensed with.

In a preferred embodiment of the use according to the invention, siloxanes of the formula (I) in which the radical A is a CH₂ group are used. In this embodiment, the radical R² is bound via an SiC linkage.

In a further preferred embodiment of the use according to the invention, siloxanes of the formula (I) in which the radical A is an oxygen atom are used. In this embodiment, the radical R² is bound via an Si—O—C linkage.

The preparation of these siloxanes is described in the German patent application DE 10 2007 046736.4, which is not a prior publication and is fully incorporated by reference into the description of the present patent application.

Here, the use of these siloxanes in the production of polyester polyurethane foams is also described.

In general, siloxanes which are used in the production of polyester polyurethane foams are not suitable for the production of cold-cure polyurethane foams. It was therefore all the more surprising that the siloxanes of the invention are able to achieve the stated object.

The present invention therefore provides for the use of a composition comprising a siloxane of the formula (I) as described in DE 10 2007 046736.4 for producing cold-cure polyurethane foams.

The siloxanes or compositions used according to the invention and processes for producing them are described by way of example below without the invention being restricted to these illustrative embodiments. Where ranges, general formulae or classes of compounds are indicated below, these are intended to encompass not only the ranges or groups of compounds which are specifically mentioned but also all other subranges and subgroups of compounds which can be obtained by taking out individual values (ranges) or compounds. If documents are cited in the present description, the contents thereof are fully incorporated by reference into the disclosure content of the present invention.

Apart from the compounds of the formula (I), the composition used according to the invention can comprise one or more bifunctional compounds of the general formula (II)

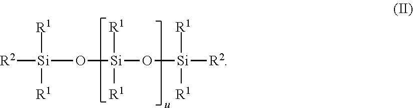

These compounds can be formed as by-product in the synthesis of the monofunctional polyethersiloxanes of the invention. The occurrence of this undesirable by-product can be largely avoided by selection of suitable reaction parameters.

Apart from the compounds of the formula (I), the composition used according to the invention can comprise one or more compounds of the general formula (III)

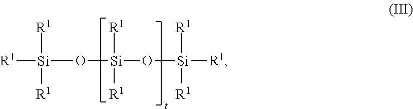

where R¹ is as defined in claim 1 and t=0 to 20, preferably 1 to 10, where when only one compound of the formula (III) is present t is the actual number of the units denoted by the index t and when a plurality of compounds of the formula (III) are present is the average of the number of units.

The proportion of siloxanes of the formula (III) based on monofunctional compounds of the formula (I) is preferably ≦25% by mass, preferably ≦15% by mass, very particularly preferably ≦10% by mass. However, it is also possible, according to the invention, to use compositions which comprise no compounds of the formula (III).

The invention further provides compositions containing siloxanes of the formulae (I), (II) and/or (III).

Preference is given to compositions which are free of siloxanes of the formula (II).

The invention further provides compositions containing siloxanes of the formulae (I) and (III).

There are many processes for producing highly elastic flexible polyurethane foams, and these have been described in detail in the literature. Thus, the published specification DE 25 33 074 A1, which is fully incorporated by reference, indicates many literature references which describe the industrial production of flexible polyurethane foams.

Furthermore, the production of flexible polyurethane foams is described in Becker/Braun, Kunststoff-Handbuch, volume 7 (editor: G. Oertel), Polyurethane, Carl Hanser Verlag, Munich; Vienna, 2nd edition, 1983, which is fully incorporated by reference.

In the production of flexible polyurethane foams, a distinction is made according to the reactivity of the raw materials between hot-cure flexible polyurethane foams (hereinafter: hot-cure foams) and cold-cure flexible polyurethane foams (hereinafter: cold-cure foams), with the terms being derived from foaming in a mold. Thus, in the case of the production of hot-cure foams by the molding process it is necessary, because of the low reactivity of the raw materials, to heat up the foam in the mold at elevated temperature, for example >90° C., to achieve complete crosslinking; these foams are therefore referred to as hot-cure foams.

On the other hand, the development of highly reactive polyether polyols and, if appropriate, the additional use of crosslinkers make it possible to carry out production of the foam in the mold with a little introduction of heat because of the rapid curing. Such foams are therefore referred to as cold-cure foams.

Apart from foaming in a mold, it is also possible to carry out foaming by the slabstock process, in which the terms cold-cure and hot-cure foam have likewise become established.

Owing to the different raw materials, cold-cure foams have very typical physical properties which distinguish them from hot-cure foams.

The cold-cure foams have:
(a) a latex-like feel,
(b) an increased elasticity compared to the conventional hot-cure foams, and these foams are therefore also referred to as “high-resilience foams” (HR foams),
(c) compressive strength characteristics different from hot-cure foam (higher sag factor) and therefore display better seating comfort when used as upholstery material (furniture foam),
(d) good long-term use properties with only a low fatigue tendency, which is of particularly great interest in the automobile sector,
(e) owing to their melting behavior, better flame resistance than conventional hot-cure foams,
(f) more favorable energy balance and shorter cycle times for foaming in a mold.

A further important feature of cold-cure foams is the rebound resilience or “ball rebound”. A method of determining the rebound resilience is described, for example, in ISO 8307. Here, a steel ball having a fixed mass is allowed to fall from a particular height onto the test specimen and the height of the rebound is then measured in % of the drop height. Typical values for a cold-cure flexible foam are above 55%. In comparison, hot-cure foams or polyurethane ester foams, hereinafter also referred to as ester foams, display rebound values of not more than 30%-48%.

To produce a cold-cure flexible polyurethane foam, a mixture of polyol, polyfunctional isocyanate, amine activator, tin catalysts, zinc catalysts or other suitable metal-containing catalysts, stabilizer, blowing agent (usually water to form CO₂ and optionally an addition of physical blowing agents), optionally with addition of further additives such as flame retardants, color pastes, fillers, crosslinkers or other customary processing aids is reacted.

The critical difference between the production of cold-cure foam and that of hot-cure foam is that highly reactive polyols and optionally also low molecular weight crosslinkers are used, with the function of the crosslinker also being able to be assumed by relatively high-functionality isocyanates. Thus, the isocyanate groups react with the hydroxyl groups even in the expansion phase (CO₂ formation from —NCO and H₂O) of the foam. This rapid polyurethane reaction leads via the increase in viscosity to a relatively high intrinsic stability of the foam during the blowing process.

Cold-cure flexible polyurethane foams are consequently highly elastic foams in which surface zone stabilization plays a great role. Owing to the high intrinsic stability, the cells are often not sufficiently opened at the end of the foaming process and have to be broken open by mechanical pressing. Here, the pressing force necessary is a measure of the proportion of open cells. Foams which have a high proportion of open cells and require only low pressing forces are desirable. In foaming in a mold, cold-cure flexible polyurethane foams are, in contrast hot-cure flexible polyurethane foams, produced at a temperature of, for example, <90° C.

The siloxanes used as additives are usually not used as pure substances but are instead incorporated as component in an appropriate formulation in order to improve the meterability or incorporatability into the reaction matrix. Thus, DE 2356443 describes various organic substances for producing formulations containing aralkyl-modified siloxane oils. WO 2008/071497 A1 describes siloxane formulations which are based on water. EP 0839852 B1 describes siloxane formulations which contain vegetable oils.

The siloxane-containing cold-cure foam stabilizer formulation of the invention has advantageous properties for controlling the cell size and cell size distribution and also regulating surface zones.

In the slabstock foaming of cold-cure flexible polyurethane foams, the necessity of opening the cells at the correct point in time and to the correct extent is, apart from foam stabilization and regulation of the cell size distribution, the actual problem. If cell opening occurs too early or too late, the foam can collapse or shrink. If a foam does not have a sufficient proportion of open cells, the opening by mechanical pressing can present problems.

Additional requirements arise in the production of a cold-cure flexible polyurethane foam molding since the expanding reaction mixture has to overcome relatively long flow distances in order to fill the entire volume of the mold. Here, destruction of entire assemblies of cells can easily occur at the walls of the mold or at inserts which have been introduced, resulting in voids under the foam skin. A further critical zone is in the region of the vents. If excess blowing gas flows past the cell assemblies at excessively high velocity, this leads to partially collapsed zones.

The cold-cure foam stabilizer formulation of the invention advantageously has the following advantages:
satisfactory stabilization of the foam,
stabilization against the influences of shear forces,
stabilization of the surface zone and the skin,
control of the cell size and the cell size distribution and also avoidance of an increased proportion of closed cells.

Cold-cure polyurethane foams can, for example, be produced by reaction of a reaction mixture consisting of
a) a polyol which bears an average of at least two hydroxy groups per molecule,
b) a polyisocyanate which bears an average of two or more isocyanate groups per molecule, where the polyol and the polyisocyanate make up the major part of the reaction mixture and the ratio of the two components is suitable for producing a foam,
c) a blowing agent in small amounts sufficient for foaming the reaction mixture,
d) a catalytic amount of a catalyst for producing the polyurethane foam, which catalyst usually consists of one or more amines, and
e) a foam stabilizer consisting of siloxanes and/or other surfactants which stabilizes the foaming mixture sufficiently.

Thus, it is possible to use the siloxanes of the general formula (I) either alone or in combination with further Si-containing or non-Si-containing surfactants as stabilizer. The siloxanes of the general formula (I) can also be diluted with suitable solvents in order to simplify metering or to improve the incorporatability into the reaction mixture.

Accordingly, the compositions used according to the invention can contain
a) a polyol which preferably bears an average of at least two hydroxy groups per molecule,
b) a polyisocyanate which preferably bears an average of two or more isocyanate groups per molecule, where the polyol and the polyisocyanate make up the major part of the composition (reaction mixture) and the ratio of the two components is suitable for producing a foam,
c) a blowing agent sufficient for foaming the reaction mixture,
d) a catalytic amount of a catalyst for producing the polyurethane foam, preferably a catalyst comprising one or more amines, and optionally
e) at least one foam stabilizer which is different from compounds of the formula (I) and stabilizes the foaming mixture sufficiently.

The polyols, isocyanates, blowing agents, flame retardants, catalysts, additives and production processes known from the prior art can be used. For example, the components mentioned in EP 0 048 984, which is hereby incorporated by reference, can be used.

The invention further provides compositions containing siloxanes of the formula (I) and optionally (II) and (III) and/or further additives or auxiliaries with which a person skilled in the art is familiar, for example: polyether polyols, polyester polyols as are used in the production of PU foam, high-boiling solvents such as aliphatic and aromatic fractions, phthalates, ester oils, glycerides, (alkyl)phenol derivatives, nonionic surfactants such as alcohols alkoxylates, anionic, cationic or amphoteric surfactants; further examples of additives which can be present in the siloxane compositions are described in the published specification DE 2 356 443.

Further additives which can be present in the composition used according to the invention are: flame retardants, cell openers, dyes, UV stabilizers, substances for preventing microbial infestation and also further additions which are obvious to those skilled in the art and are not described in more detail here.

The siloxanes used according to the invention can be prepared in a known manner as described in the prior art.

The siloxanes of the invention are preferably prepared by the process described in DE 10 2007 046736.4.

The invention further provides a process for producing cold-cure polyurethane foams using compositions containing the linear siloxanes described.

The invention further provides a cold-cure polyurethane foam produced by such a process using the linear siloxanes.

Furthermore, the invention provides consumer articles containing a cold-cure polyurethane foam produced in such a way, for example an automobile seat containing a corresponding cold-cure polyurethane foam.

The invention further provides a consumer article consisting of a cold-cure polyurethane foam produced by the process of the invention using the composition containing linear siloxanes.

The present invention is described by way of example in the following examples without the invention, whose scope is defined by the total description and the claims, being restricted to the embodiments mentioned in the examples. Further subjects of the invention are defined in the claims, whose disclosure content is fully incorporated into the present description.

### EXAMPLES

### General

The siloxanes according to the invention were prepared by the process described in DE 10 2007 046736.

The viscosities reported were, unless indicated otherwise, measured in accordance with DIN 53015 at 20° C. using a Höppler falling ball viscometer.

### Syntheses

### Preparation of the Siloxanes

### Example 1

### Preparation of Siloxane A

A linear siloxane was prepared as described in DE 10 2007 046736 under Example 5.

### Example 2

### Preparation of Siloxane B

A linear siloxane was prepared as described in DE 10 2007 046736 under Example 10.

### Example 3

### Preparation of Siloxane C

In a four-neck flask equipped with a precision glass stirrer, an internal thermometer and a reflux condenser, 743.5 g of an α,ω-dihydrogenpolydimethylsiloxane having a hydrogen content of 2.69 eq of SiH/kg, 724.2 g of hexamethyldisiloxane and 0.86 ml of trifluoromethane-sulfonic acid were stirred at 40° C. for six hours. After addition of 29.4 g of sodium hydrogencarbonate, the mixture was stirred at room temperature for 30 minutes and the solid was filtered off.

In a next step, 53.0 g of Golpanol® BEG from BASF are dissolved in 46.4 g of butyl acetate in a four-neck flask equipped with a precision glass stirrer, an internal thermometer, a dropping funnel and a distillation attachment and heated to 80° C. while stirring. 20 ppm of platinum in the form of a platinum(0) catalyst modified as described in EP 1520870 were added and 220 g of the hydrogensiloxane prepared in the first step were added dropwise over a period of 2 hours. After the addition is complete, the mixture is stirred at 80° C. for a further two hours. The reaction conversion determined by gas volumetry is quantitative. Distillation at 130° C. in an oil pump vacuum of less than 2 mbar gives an orange-yellow, transparent product having a viscosity of 44.5 mPa*s.

### Example 4

### Preparation of Siloxane D

A linear siloxane was prepared as described in DE 10 2007 046736 under Example 11.

### Example 5

### Preparation of Siloxane E

In a four-neck flask equipped with a precision glass stirrer, an internal thermometer and a reflux condenser, 215.0 g of a butanol-initiated polypropylene glycol having an average molar mass of 1800 g/mol are heated at 110° C. for one hour. The mixture is then cooled to 90° C. and 500 ppm of tris(pentafluoro-phenyl)borane are added. 47.0 g of the hydrogensiloxane from Example 4 are added dropwise at 90° C. over 30 minutes while stirring. The reaction conversion determined by gas volumetry is quantitative after 2 hours. A clear, virtually colorless product having a viscosity of 187.4 mPa*s is obtained.

### Example 6

### Preparation of Siloxane F

A linear siloxane was prepared by hydrosilylation of an allyl alcohol-initiated, EO-containing polyether having methyl end caps (average molar mass of 400 g/mol) by means of a siloxane equilibrate as described in DE 10 2007 046736 under Example 11, with the removal of volatile materials under reduced pressure after the end of the reaction being omitted.

### Example 7

### Preparation of Siloxane G

A linear siloxane was prepared by hydrosilylation of an allyl alcohol-initiated, EO/PO-containing polyether (average molar mass of 500 g/mol, about 60% of EO, 40% of PO) by means of a siloxane equilibrate as described in DE 10 2007 046736 under Example 11, with the removal of volatile materials under reduced pressure after the end of the reaction being omitted.

### Example 8

### Preparation of Siloxane H

In a four-neck flask equipped with a precision glass stirrer, an internal thermometer and a reflux condenser, 125.5 g of an allyl alcohol-initiated polyethylene glycol having an average molar mass of 400 g/mol are heated to 70° C. while stirring and 6 ppm of platinum in the form of a platinum(0) catalyst modified as described in EP 1 520 870 are added. 130.0 g of the hydrogensiloxane from Example 4 are added dropwise over a period of 30 minutes. The reaction conversion determined by gas volumetry is quantitative after 2 hours. A clear, slightly yellowish product having a viscosity of 39.2 mPa*s is obtained.

### Example 9

### Preparation of Siloxane I

In a four-neck flask equipped with a precision glass stirrer, an internal thermometer and a reflux condenser, 166.3 g of an allyl alcohol-initiated polyether having an average molar mass of 830 g/mol, 20 parts by weight of ethylene oxide and 80 parts by weight of propylene oxide are heated with 85.0 g of the hydrogensiloxane from Example 4 to 70° C. while stirring and 6 ppm of platinum in the form of a platinum(0) catalyst modified as described in EP 1 520 870 are added. The reaction conversion determined by gas volumetry is quantitative after 2 hours. A clear, slightly yellowish product having a viscosity of 51.4 mPa*s is obtained.

### Example 10

### Preparation of Siloxane J

In a four-neck flask equipped with a precision glass stirrer, an internal thermometer and a reflux condenser, 152.0 g of an allyl alcohol-initiated, methyl ether-end-capped polyether having an average molar mass of 600 g/mol, 40 parts by weight of ethylene oxide and 60 parts by weight of propylene oxide are heated to 70° C. while stirring and 6 ppm of platinum in the form of a platinum(0) catalyst modified as described in EP 1520870 are added. 95.0 g of the hydrogensiloxane from Example 4 are added dropwise over a period of 20 minutes. The reaction conversion determined by gas volumetry is 98% after 6 hours. A clear, slightly yellowish product having a viscosity of 22.5 mPa*s is obtained.

### Comparative Example 1

### Preparation of Siloxane K

### Not According to the Invention

Siloxanes of the formula (II) which are not according to the invention are prepared by means of the altered formulation, here the altered ratio of the components relative to one another compared to DE 2007046736.

In a four-neck flask equipped with a precision glass stirrer, an internal thermometer and a reflux condenser, 269.4 g of an α,ω-dihydrogenpolydimethylsiloxane having a hydrogen content of 2.69 eq of SiH/kg, 16.2 g of hexamethyldisiloxane and 0.16 ml of trifluoromethanesulfonic acid were stirred at 40° C. for six hours. After addition of 5.7 g of sodium hydrogencarbonate, the mixture was stirred at room temperature for 30 minutes and the solid was filtered off.

In a next step, 183.7 g of an allyl alcohol-initiated polyether having an average molar mass of 830 g/mol, 20 parts by weight of ethylene oxide and 80 parts by weight of propylene oxide are heated with 65.0 g of the hydrogensiloxane prepared in the first step to 70° C. while stirring in a four-neck flask equipped with a precision glass stirrer, an internal thermometer and a reflux condenser and 6 ppm of platinum in the form of a platinum(0) catalyst modified as described in EP 1520870 are added. The reaction conversion determined by gas volumetry is quantitative after 2 hours. A clear, slightly yellowish product having a viscosity of 112 mPa*s is obtained.

### Production of Cold-Cure Polyurethane Foam

### Formulation A

100 parts of polyol having an OH number of 35 mg KOH/g and a molar mass of 5000 g/mol, various parts of siloxane composition, where the composition consisted of a 10% strength solution of the corresponding siloxane in a butanol-initiated polypropylene glycol having a molar mass of 700, 3 parts of water, 2 parts of triethanolamine, 0.6 part of TEGOAMIN® 33 and 0.2 part of diethanolamine and a mixture of 18.5 parts of polymeric MDI (44V20 from Bayer) and 27.7 parts of TDI (T80=tolylene 2,4- and 2,6-diisocyanate isomer mixture in a ratio of 80:20).

### Formulation B

90 parts of polyol having an OH number of 32 mg KOH/g and a molar mass of 5500 g/mol, 10 parts of a polymer polyol (43% styrene-acrylonitrile polymer, SAN) having an OH number of 20 mg KOH/g and a molar mass of 5000 g/mol, (various) parts of siloxane composition consisting of a 10% strength solution of the corresponding siloxane in a butanol-initiated polypropylene glycol having a molar mass of 700, 4 parts of water, 0.9 part of diethanolamine, 0.4 part of TEGOAMIN® MS 40, 0.06 part of TEGOAMIN® BDE, 0.6 part of glycerol and 46 parts of isocyanate (T80=tolylene 2,4- and 2,6-diisocyanate isomer mixture in a ratio of 80:20).

### Formulation C

100 parts of polyol having an OH number of 29 mg KOH/g and a molar mass of about 6000 g/mol, various parts of siloxane composition consisting of a 10% strength solution of the corresponding siloxane in a butanol-initiated polypropylene glycol having a molar mass of 400, 4.1 parts of water, 1.3 parts of diethanolamine, 0.08 part of TEGOAMIN® 33, 0.05 part of TEGOAMIN® BDE, 0.2 part of Ortegol® 204, 0.075 part of Kosmos® 29 and 1.0 part of Voranol CP 1421 (from Dow) and 49 parts of isocyanate (T80=tolylene 2,4- and 2,6-diisocyanate isomer mixture in a ratio of 80:20).

### Production of Molded Foam Using Formulation A

The foams were produced in the known way by mixing all components other than the isocyanate in a cup, subsequently adding the isocyanate and stirring it in quickly at a high stirrer speed. The reaction mixture was then poured into a cuboidal mold which had the dimensions 40×40×10 cm and had been heated to a temperature of 40° C. and allowing the composition according to the formulation to cure for 10 minutes. The compressive forces for opening the cells were subsequently measured. Here, the foams were compressed 10 times to 50% of its height. Here, the 1st measured value (AD 1 in newton) is a measure of the proportion of open cells in the foam. These cells were subsequently opened completely (manually) in order to be able to determine the hardness of the opened foam at the 11th measured value (AD 11 in newton). The foams were then cut open to assess the skin and surface zone and determine the cell count (CC).

Examples 11 to 13 are summarized in the following table. The assessments, added amount of the siloxane composition in parts per hundred parts of polyols (pphp) and the siloxane used in each case are shown.

Table for molded foam, formulation A:

| | | | | | Sur- | | Added |
|---|---|---|---|---|---|---|---|
| | | | | | face | | amount/ |
| Ex. | AD 1 | AD 11 | CC | Skin | zone | Siloxane | pphp |
| 11 | 1217 | 128 | 10 | good | good | A | 0.25 |
| 12 | 1243 | 122 | 10 | good | good | B | 0.25 |
| 13 | 1322 | 136 | 10 | good | good | C | 0.25 |

### Production of Molded Foam Using Formulation B

The foams were produced in the known way by mixing all components apart from the isocyanate in a cup, subsequently adding the isocyanate and stirring it in quickly at a high stirrer speed. The reaction mixture was then poured into an industrial mold for an automobile seat which had been heated to a temperature of 65° C. and the composition was allowed to cure for 6 minutes. The ability to break open the cells of the foam (AD) was subsequently assessed according to grades 1-10, where grade 1 denotes a very open-celled foam and grade 10 denotes a very closed-celled foam. In addition, the flow (FL) of the foaming composition was assessed according to grades from 1 to 5, where 1 denotes very good flow and 5 denotes very poor flow. These effects emerge particularly at constrictions in the mold. The foams were then cut open to assess the quality (skin and surface zone) and determine the cell count (CC). Examples 14 to 23 and Comparative Examples 2 and 3 are summarized in the following table. The assessments of the siloxane used in each case and the added amounts of the siloxane composition in pphp are shown.

Table for molded foam, formulation B:

| | | | | | Surface | | Added |
|---|---|---|---|---|---|---|---|
| Ex. | AD | FL | CC | Skin | zone | Siloxane | amount |
| 14 | 4 | 2 | 11 | good | good | D | 1.5 |
| 15 | 3 | 2 | 11 | good | very | E | 1.5 |
| | | | | | good | | |
| 16 | 3 | 2 | 11 | good | very | F | 1.5 |
| | | | | | good | | |
| 17 | 2 | 2 | 11 | good | good | G | 1 |
| 18 | 2 | 2 | 10 | good | good | H | 1.5 |
| 19 | 2 | 3 | 10 | good | good | H | 0.7 |
| 20 | 4 | 2 | 11 | good | good | I | 1.5 |
| 21 | 2 | 3 | 10 | good | good | I | 0.7 |
| 22 | 3 | 3 | 11 | very | good | J | 1.5 |
| | | | | good | | | |
| 23 | 2 | 3 | 11 | good | good | J | 0.7 |
| Comp. | 9 | 5 | 11 | moder- | moder- | K | 1.5 |
| 2 | | | | ate | ate | | |
| Comp. | 9 | 4 | 11 | moder- | moder- | K | 0.7 |
| 3 | | | | ate | ate | | |

It can be seen here that good foam qualities are achieved over a wide concentration range with the siloxanes according to the invention, while the quality becomes significantly poorer when using siloxanes of the formula (II), which are not according to the invention since the foams become too closed and tend to shrink.

### Production of Slabstock Foam Using Formulation C

The foams were produced in the known way by mixing all components apart from the isocyanate in a cup, subsequently adding the isocyanate and stirring it in quickly at a high stirrer speed. The reaction mixture was then poured into a paper-lined container having a base of 28×28 cm. The rise height (RH in cm) and the settling (Se in cm) were determined. The blowing-off (BO) of the foam was evaluated according to grades of 0-3, where 0 denotes poor or not discernible blowing-off and 3 denotes very strong blowing-off, with a value of 1-2 being sought.

Settling refers to the decrease in the rise height in cm 1 minute after the maximum rise height has been reached. Blowing-off is the escape of the blowing gases from the open cells of the foam.

After curing of the foam, it was cut open and the cell count (CC in cm⁻¹) was determined, and the quality of the foam (cell size distribution, surface zones) was generally assessed.

Examples 24 to 27 are summarized in the following table. The assessments, the siloxane used in each case and the added amount of the siloxane composition in pphp are shown.

Table for slabstock foam, formulation C:

| | | | | | | | Added |
|---|---|---|---|---|---|---|---|
| Ex. | RH | Se | BO | CC | Quality | Siloxane | amount |
| 24 | 28.8 | 0.2 | 1.5 | 11 | good | E | 0.8 |
| 25 | 29.1 | 0.1 | 1 | 11 | good | H | 0.8 |
| 26 | 28.4 | 0.4 | 1.5 | 11 | good | J | 0.8 |
| 27 | 29.7 | 0.2 | 1 | 11 | good | J | 0.6 |

These examples shows that the siloxanes according to the invention are also suitable for producing HR slabstock foams of good quality.

1. A method for producing cold-cure polyurethane foams which comprises adding a composition containing linear siloxanes which contain only one further organically modifying group which is bound to a terminal silicon atom in addition to the Si-alkyl substitution in the chain.

2. A composition containing linear siloxanes of the formula (I) 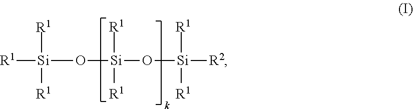
where
the radicals R¹ are identical or different, straight-chain or branched, aliphatic or aromatic, optionally halogenated, optionally unsaturated hydrocarbon radicals having from 1 to 8 carbon atoms,
k is from 0 to 30, and when only one compound of the formula (I) is present k is the actual number of the units denoted by the index k and when a plurality of compounds of the formula (I) is present is the average of the number of units,
R² is a group of the formula A-B-D-Q, where
A is an oxygen atom, a CH₂ group or a CH═CH group,
B is a CH₂ group or a divalent radical selected from among linear or branched, saturated, monounsaturated or multiply unsaturated alkyloxy, aryloxy, alkylaryloxy or arylalkyloxy groups having from 2 to 20 carbon atoms or a group of the formula —CH₂—O—(CH₂)₄—O— (where this is inserted as A-CH₂—O—(CH₂)₄—O-D-Q in R²),
D is a group of the general formula (II)
—(C₂H₄O)ₙ(C₃H₆O)ₒ(C₁₂H₂₄O)ₚ(C₈H₈O)_{q}(C₄H₈O)ᵣ— (II)
Q is a radical selected from among hydrogen, linear or branched, saturated, monounsaturated or multiply unsaturated, alkyl, aryl, alkylaryl or arylalkyl groups having from 1 to 20 carbon atoms, optionally containing one or more heteroatoms, optionally containing one or more carbonyl groups, optionally modified with an ionic organic group,
or industrial mixtures containing these compounds or consisting of at least one compound of the formula (I).

3. The composition containing linear siloxanes as claimed in claim 2 having a radical R² which is bound via a carbon atom (SiC linkage) or an oxygen atom (SiOC linkage).

4. A composition containing compounds corresponding to claim 2, characterized in that all radicals R¹ of the general formula (I) are methyl groups.

5. A composition containing compounds corresponding to claim 2, characterized in that p=q=r=0, the sum of the indices n+o is greater than or equal to 3 and Q is selected from the group consisting of hydrogen and 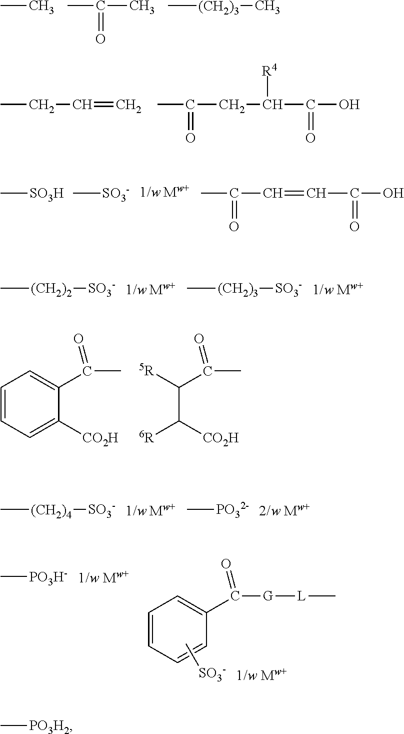
where
M^{w+} is a w-valent cation where w=1, 2, 3 or 4, in particular K⁺, Na⁺, NH₄⁺, (iC₃H₇)NH₃⁺ or (CH₃)₄N⁺ and
R⁴ is hydrogen or an optionally branched aliphatic radical having from 1 to 20 carbon atoms,
R⁵ and R⁶ are identical or different, bridged or unbridged, branched or unbranched aliphatic radicals,
G is an oxygen atom, NH or an NR⁷ group, where R⁷ is a monovalent alkyl group, and
L is a divalent branched or unbranched, optionally oxygen- and/or nitrogen-containing, alkyl radical, preferably a radical having from 3 to 6 carbon atoms and 0 or 1 nitrogen atom.

6. The composition as claimed in claim 4, characterized in that it contains compounds of the formula (I) in which the radicals R¹ of the general formula (I) are exclusively methyl groups, p=q=r=0, the sum of the indices n+o is greater than or equal to 3 and Q is selected from the group consisting of hydrogen, acetyl, methyl, ethyl, butyl and allyl radicals.

7. The composition as claimed in claim 3, characterized in that, in the formula (I), the radical A is a CH₂ group and the radical R² is therefore bound via an SiC linkage.

8. The composition as claimed in claim 3, characterized in that, in the formula (I), the radical A is an oxygen atom and the radical R² is therefore bound via an Si—O—C linkage.

9. (canceled)

10. A composition containing the linear siloxanes of the formulae (I), (II) and/or (III), 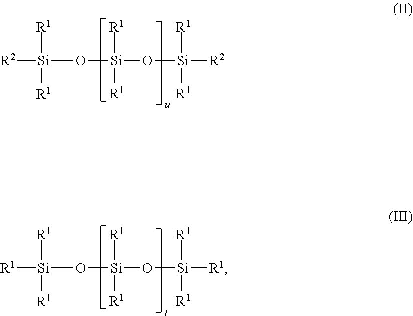
where R¹ is as defined in claim 2 and t=0 to 20.

11. The composition as claimed in claim 10, characterized in that the content of linear siloxanes of the formula (III) is ≦25% by mass.

12. The composition as claimed in claim 10, characterized in that no siloxanes of the formula (II) are present.

13. The composition as claimed in claim 4 containing linear siloxanes of the formula (I) and optionally (II) and (III) and/or further additives or auxiliaries selected from the group consisting of polyether polyols, polyester polyols, high-boiling solvents, phthalates, ester oils, glycerides, (alkyl)phenol derivatives, nonionic surfactants and alcohol alkoxylates.

14. The composition as claimed in claim 4, characterized in that flame retardants, cell openers, dyes, UV stabilizers, substances for preventing microbial infestation are present.

15. A method of claim 1, wherein the linear siloxanes used are of the formula (I) 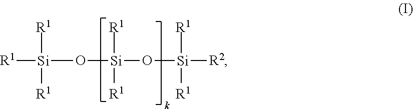
where
the radicals R¹ are identical or different, straight-chain or branched, aliphatic or aromatic, optionally halogenated, optionally unsaturated hydrocarbon radicals having from 1 to 8 carbon atoms,
k is from 0 to 10, and when only one compound of the formula (I) is present k is the actual number of the units denoted by the index k and when a plurality of compounds of the formula (I) is present is the average of the number of units,
R² is a group of the formula A-B-D-Q, where
A is an oxygen atom, a CH₂ group or a CH═CH group,
B is a CH₂, group or a divalent radical selected from among linear or branched, saturated, monounsaturated or multiply unsaturated alkyloxy, aryloxy, alkylaryloxy or arylalkyloxy groups having from 2 to 20 carbon atoms or a group of the formula —CH₂—O—(CH₂)₄—O— (where this is inserted as A-CH₂—O—(CH₂)₄—O-D-Q in R²),
D is a group of the general formula (II)
—(C₂H₄O)ₙ(C₃H₆O)ₒ(C₁₂H₂₄O)ₚ(C₈H₈O)_{q}(C₄H₈O)ᵣ— (II)
Q is a radical selected from among hydrogen, linear or branched, saturated, monounsaturated or multiply unsaturated, alkyl, aryl, alkylaryl or arylalkyl groups having from 1 to 20 carbon atoms, optionally containing one or more heteroatoms, optionally containing one or more carbonyl groups, optionally modified with an ionic organic group,
or industrial mixtures containing these compounds or consisting of at least one compound of the formula (I).

16. A cold-cure polyurethane foam produced by a process as claimed in claim 15.

17. A consumer article containing a cold-cure polyurethane foam as claimed in claim 16.

18. An automobile seat containing a cold-cure polyurethane foam as claimed in 16.

19. A consumer article consisting of a cold-cure polyurethane foam as claimed in claim 17.

20. The composition of claim 2, wherein 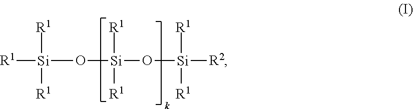
where
the radicals R¹ are identical or different, straight-chain or branched, aliphatic or aromatic, optionally halogenated, optionally unsaturated hydrocarbon radicals having one carbon atom,
k is from 0 to 10, and when only one compound of the formula (I) is present k is the actual number of the units denoted by the index k and when a plurality of compounds of the formula (I) is present is the average of the number of units,
R² is a group of the formula A-B-D-Q, where
A is an oxygen atom, a CH₂ group or a CH═CH group,
B is a CH₂ group or a divalent radical selected from among linear or branched, saturated, monounsaturated or multiply unsaturated alkyloxy, aryloxy, alkylaryloxy or arylalkyloxy groups having from 2 to 20 carbon atoms or a group of the formula —CH₂—O—(CH₂)₄—O— (where this is inserted as A-CH₂—O—(CH₂)₄—O-D-Q in R²),
D is a group of the general formula (II)
—(C₂H₄O)ₙ(C₃H₆O)ₒ(C₁₂H₂₄O)ₚ(C₈H₈O)_{q}(C₄H₈O)ᵣ— (II)
Q is a radical selected from among hydrogen, linear or branched, saturated, monounsaturated or multiply unsaturated, alkyl, aryl, alkylaryl or arylalkyl groups having from 1 to 20 carbon atoms, optionally containing one or more heteroatoms, optionally containing one or more carbonyl groups, optionally modified with an ionic organic group, which optionally contain a heteroatom selected from the group consisting of sulfur, phosphorus, nitrogen and combinations thereof,
or industrial mixtures containing these compounds or consisting of at least one compound of the formula (I).

21. The composition of claim 5, wherein
L is a divalent branched or unbranched, optionally oxygen- and/or nitrogen-containing, alkyl radical having from 3 to 6 carbon atoms and 0 or 1 nitrogen atom.
